(19) United States
(12) Patent Application Publication
(10) Pub. No.: US 2026/0332711 A1
(43) Pub. Date: Oct. 22, 2026

(54) IMAGE READING APPARATUS, CONTROL METHOD THEREFOR, AND STORAGE MEDIUM

(71) Applicant: CANON KABUSHIKI KAISHA, Tokyo (JP)

(72) Inventor: SHIYUYA IMOTO, Kanagawa (JP)

(21) Appl. No.: 19/650,761

(22) Filed: Apr. 17, 2026

(30) Foreign Application Priority Data
Apr. 21, 2025 (JP) 2025-069891

(51) Int. Cl. H04N 1/00

(52) U.S. Cl. CPC H04N 1/00814; H04N 1/0071

(57) ABSTRACT

An image reading apparatus includes a conveyance roller that conveys a document, a plurality of image sensors that read an image of the document conveyed by the conveyance roller, an acquisition unit that acquires eccentricity information of the conveyance roller for each of a plurality of areas in a direction intersecting a conveyance direction of the document, and a correction unit that corrects reading timings of the plurality of image sensors based on the eccentricity information, wherein the correction unit selects eccentricity information to be used for calculation of a correction value from the eccentricity information of the plurality of areas based on a width of the document.

### BACKGROUND

### Cross-Reference to Priority Application

This application claims the benefit of Japanese Patent Application No. 2025-069891, filed Apr. 21, 2025, which is hereby incorporated by reference herein in its entirety.

### Field of the Technology

The present disclosure relates to a technology for suppressing deterioration in quality of a read image due to eccentricity of a document feeding roller.

### Description of Related Art

In a wide-width image reading apparatus, instead of using a long image sensor, there is a configuration in which a plurality of A4-size or A3-size image sensors are arranged to realize a desired reading width in order to reduce the cost of the apparatus. In such a configuration, it is necessary to join read images of each image sensor to form one image.

In order to join read images of a plurality of image sensors to form a high-precision image, it is necessary to accurately detect the amount of displacement of each image sensor. A process of joining images is performed according to the amount of displacement. However, image displacement between image sensors occurs not only due to relative displacement of positions of the image sensors but also due to variations in feeding amounts of conveyance rollers for conveying a read document. Compared to an ideal conveyance roller, a conveyance roller that is actually manufactured may have an eccentricity component due to a tolerance of a central axis or the like.

In a case where an eccentricity component is present, a change occurs in the conveyance amount of a document for each angle of the roller. In a configuration of an apparatus in which a plurality of image sensors are arranged with a distance in a conveyance direction, in a case where the distance is other than an integer multiple of a circumferential length of the roller, an image is formed by overlapping a portion processed on the upstream side of conveyance and a portion processed on the downstream side of conveyance. In such a case, periodic image displacement for each rotation of the roller occurs in the overlapping portion.

To address this problem, Japanese Patent Application Laid-Open No. 2012-000839 provides a configuration in which, when generating a timing signal from a pulse of an encoder, a delay time until generation of the timing signal and a cycle of the generated timing signal are set for each pulse. It is stated that with this configuration, even in a case where displacement occurs in a pulse cycle of the encoder, timing signals can always be generated at constant intervals.

### SUMMARY

The present disclosure has been made in view of the above-mentioned problems, and in an image reading apparatus, suppresses deterioration in quality of a read image due to eccentricity of a conveyance roller.

According to an aspect of the present disclosure, there is provided an image reading apparatus comprising: a conveyance roller that conveys a document; a plurality of image sensors that read an image of the document conveyed by the conveyance roller; at least one processor or circuit and a memory storing instructions to cause the at least one processor or circuit to perform operations of the following units: an acquisition unit that acquires eccentricity information of the conveyance roller for each of a plurality of areas in a direction intersecting a conveyance direction of the document; and a correction unit that corrects reading timings of the plurality of image sensors based on the eccentricity information, wherein the correction unit selects eccentricity information to be used for calculation of a correction value from the eccentricity information of the plurality of areas based on a width of the document.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIGS. 1A-1C are views showing an inkjet multifunction peripheral, which is one embodiment of an image reading apparatus of the present disclosure.

FIG. 2 is an internal block diagram of the multifunction peripheral.

FIG. 3 is a view showing concepts of eccentricity information acquisition and a document scan operation.

FIGS. 4A-4C are views showing image expansion/contraction for each area, correction information for each area, and correction residual.

FIG. 5 is a view showing a skewed read document and thresholds set for each document width.

FIG. 6 is a flowchart showing an operation of calculating an eccentricity correction value in the first embodiment.

FIGS. 7A and 7B are flowcharts showing an operation of calculating an eccentricity correction value in the second embodiment.

### DESCRIPTION OF THE EMBODIMENTS

Hereinafter, embodiments will be described in detail with reference to the attached drawings. Note that the following embodiments do not limit the scope of the claims. Although a plurality of features are described in the embodiments, not all of these plurality of features are necessarily required, and the plurality of features may be arbitrarily combined. Furthermore, in the attached drawings, the same or similar configurations are denoted by the same reference numbers, and redundant descriptions are omitted.

When correcting the rotation timing of a roller for eccentricity of a conveyance roller, a problem arises that image displacement cannot be completely corrected unless the eccentricity component of the conveyance roller is uniform in a main scanning direction (a direction orthogonal to a conveyance direction).

For example, in a case where a rubber roller is used as the conveyance roller, individual rubber members have eccentricity components, and non-uniform changes in the conveyance amount for each part are exhibited. In a case where the size of the document is large and the number of nipped rubber members is large, the influence of variations of these individual rubber members becomes small, but in a case where the document size is small, the number of rubber members used for nipping is small, and individual variations may have more of an effect.

Also, in an image reading apparatus that forms an image by joining read images of a plurality of image sensors, there is an image sensor that is not used for reading a document depending on the size of the read document. Even at a location where there is no read document on a conveyance path, eccentricity information to be used for correction of an image can be acquired. Therefore, if eccentricity information of a location where there is no read document on the conveyance path among a plurality of pieces of eccentricity information acquired on the document conveyance path is used for calculation of a correction value, it affects correction displacement.

### Image Reading Operation

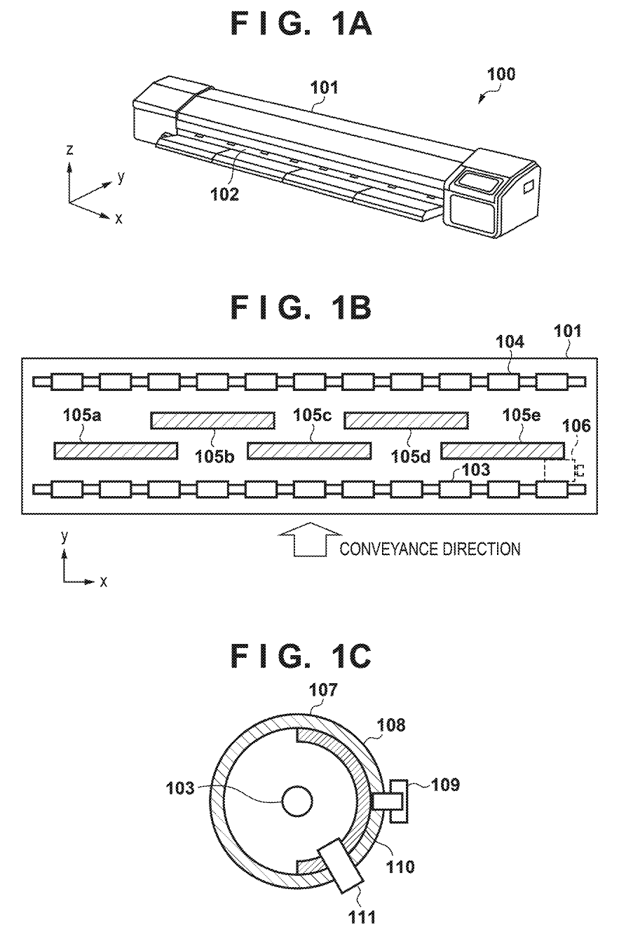

FIGS. 1A-1C are views showing an inkjet multifunction peripheral 100 (hereinafter multifunction peripheral), which is one embodiment of the image reading apparatus of the present disclosure. FIG. 1A is an external perspective view of a scanner unit 101 of the multifunction peripheral 100, and FIG. 1B is an internal top view of the scanner unit 101.

The scanner unit 101 is a sheet-feed type reading apparatus, and performs reading of an image while conveying a document fed from a document feeding port 102.

Inside the scanner unit 101, an upstream conveyance roller 103 and a downstream conveyance roller 104 are arranged, and between them, five image sensor units 105ato 105eare arranged in a staggered manner in a direction intersecting the conveyance direction.

The conveyance rollers 103, 104 are rubber rollers, and are configured by mounting a plurality of rubber rollers on a metal shaft at predetermined intervals. A gear is mounted on the upstream conveyance roller 103, and rotation of a conveyance motor 106 is transmitted through this gear, whereby the upstream conveyance roller 103 is rotated.

Furthermore, the upstream conveyance roller 103 and the downstream conveyance roller 104 are connected by a belt, and the downstream conveyance roller 104 also rotates in the same direction by rotation of the upstream conveyance roller 103. Driven rollers are respectively arranged at positions facing the conveyance rollers 103, 104, and are configured to nip and convey a document by the conveyance roller and the driven roller.

In the upstream conveyance roller 103, a code wheel 107 is mounted on an end portion. FIG. 1C shows a configuration of the code wheel 107 mounted on the upstream conveyance roller 103 and its surroundings.

In the code wheel 107, a slit disk 108 provided with many fine slits in a circumferential direction is mounted, and an encoder sensor 109 is mounted so as to sandwich the slit disk 108. A pattern 110 for reference position detection is printed on the inside of the slit disk 108, and an HP sensor (home position sensor) 111 is mounted so as to sandwich the pattern 110. The HP sensor 111 is a photo-interrupter, and can detect a rising edge portion of a detection signal of the pattern 110 as a reference position of the code wheel 107. In the present embodiment, the encoder sensor 109 has a resolution of 19200 lpi, and can obtain pulse signals for 51200 pulses in one rotation of the code wheel.

One image sensor unit 105 has a reading width capable of reading A4 size, and by joining these, a read image of 36-inch width can be obtained. A pressing plate is mounted at a position facing the image sensor unit 105, and has a role of pressing so that the document contacts a reading surface of the image sensor unit 105. Note that in FIGS. 1A-1C, a direction indicated by x is called a main scanning direction, and a direction indicated by y is called a sub-scanning direction.

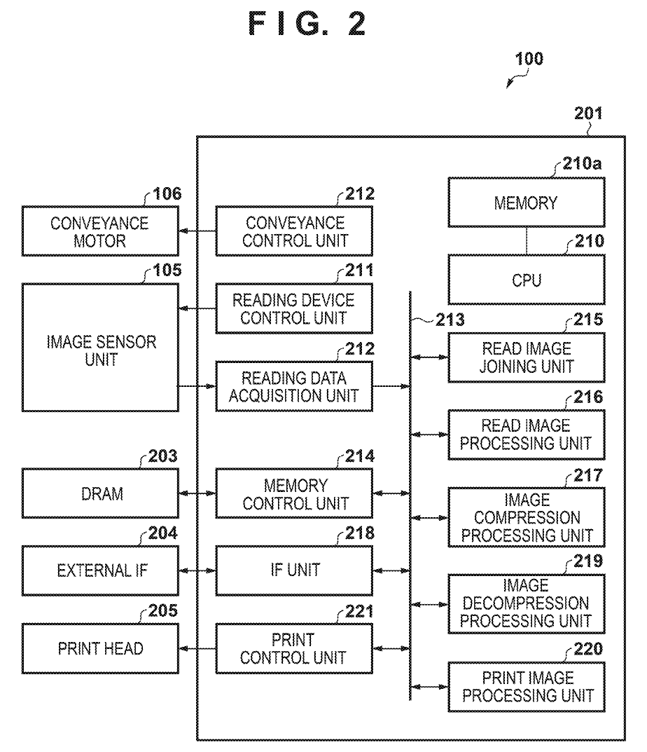

FIG. 2 is a block diagram for explaining an electrical configuration of the multifunction peripheral 100.

An ASIC 201 is mounted on a printed circuit board unit installed in the multifunction peripheral 100, and controls each unit to cause the multifunction peripheral 100 to perform each operation.

A DRAM 203 is used as a buffer or the like for temporarily storing image data read by the image sensor unit 105 and image data for printing.

An external IF 204 is an interface for outputting read image data to the outside or receiving input of print data from the outside, and includes USB, LAN, and the like.

The print head 205 performs printing on a recording medium by an inkjet method.

Next, internal blocks of the ASIC 201 will be described.

The CPU 210 performs control of each internal control block, image processing of read image data, calculation of parameters for correction, and the like. Note that control of each control block is performed by executing a program stored in a memory 210a.

A conveyance control unit 222 is connected to a motor driver circuit outside the ASIC 201, and the motor driver circuit is connected to the conveyance motor 106. The conveyance control unit 222 outputs a control signal to the motor driver circuit, and the motor driver circuit receives it and outputs a drive signal to the conveyance motor 106, whereby the conveyance motor 106 can be rotated.

A reading device control unit 211 is connected to the image sensor units 105ato 105e, the encoder sensor 109, the HP sensor 111, and the like. It outputs a trigger signal indicating start of reading, an LED control signal, a mode control signal, and the like to the image sensor unit 105.

A reading data acquisition unit 212 is connected to the image sensor units 105ato 105e, and performs processing for converting data output from each of the image sensor units 105ato 105e into pixel data and processing for rearranging it according to an arrangement of pixels. Also, it performs shading processing for reducing optical variations and sensitivity variations of light-receiving elements, gamma correction processing for correcting linearity of output, and the like. The reading data acquisition unit 212 includes five systems of processing circuits so as to be able to individually perform processing on data of each of the five image sensor units 105a to 105e. The reading data acquisition unit 212 is connected to an internal bus 213 inside the ASIC 201.

The internal bus 213 is connected to a memory control unit 214, which is an interface for the DRAM 203.

The reading data acquisition unit 212 has a built-in DMAC (Direct Memory Access Controller) (not shown), and writes acquired read data into a read image buffer area of the DRAM 203 via the internal bus 213 and the memory control unit 214.

A read image joining unit 215 is a processing circuit for joining read data acquired from a plurality of image sensor units 105. It includes a circuit for, in performing joining, correcting mounting variations and color sensitivity variations of the image sensor unit 105 and a circuit for changing resolution. The read image joining unit 215 is connected to the internal bus 213, and a plurality of DMACs in the read image joining unit 215 perform reading and writing of image data from and to buffer areas of the DRAM 203 via the memory control unit 214. Finally, a processing result of image data read from the read image buffer area of the DRAM 203 is written into a joined image buffer area of the DRAM 203.

A read image processing unit 216 is a processing circuit for processing and correcting image data joined in the read image joining unit 215 according to an application, and can perform edge enhancement processing, rotation processing, scaling processing, and the like of image data. The read image processing unit 216 is connected to the internal bus 213, reads image data from the joined image buffer area of the DRAM 203 via the memory control unit 214, and writes processed image data into a processed image buffer area of the DRAM 203.

An image compression processing unit 217 is a processing circuit for compressing image data. The image compression processing unit 217 is connected to the internal bus 213, reads image data of the processed image buffer area of the DRAM 203 via the memory control unit 214, and performs compression processing. Compressed image data is written into a compressed image buffer area of the DRAM 203 via the memory control unit 214. When outputting read image data to the outside, the image data written in the compressed image buffer area of the DRAM 203 is output to the outside via an IF unit 218.

An image decompression processing unit 219 is a processing circuit for decompressing compressed image data. The image decompression processing unit 219 is connected to the internal bus 213, reads image data written in the compressed image buffer area of the DRAM 203 subjected to compression processing, performs decompression processing, and writes the result into a decompressed image buffer area of the DRAM 203.

A print image processing unit 220 is a processing circuit for converting image data into data according to print settings. The print image processing unit 220 is connected to the internal bus 213, reads image data of the processed image buffer area or the decompressed image buffer area of the DRAM 203 via the memory control unit 214, and performs processing. Processed image data is written into a print data buffer area of the DRAM 203 via the memory control unit 214.

A print control unit 221 is a processing circuit for converting image data converted into print data into a drive signal for the inkjet print head 205. The print control unit 221 is connected to the internal bus 213, reads data of the print data buffer area of the DRAM 203 via the memory control unit 214, converts it into a drive signal for the print head 205, and outputs it to the print head 205.

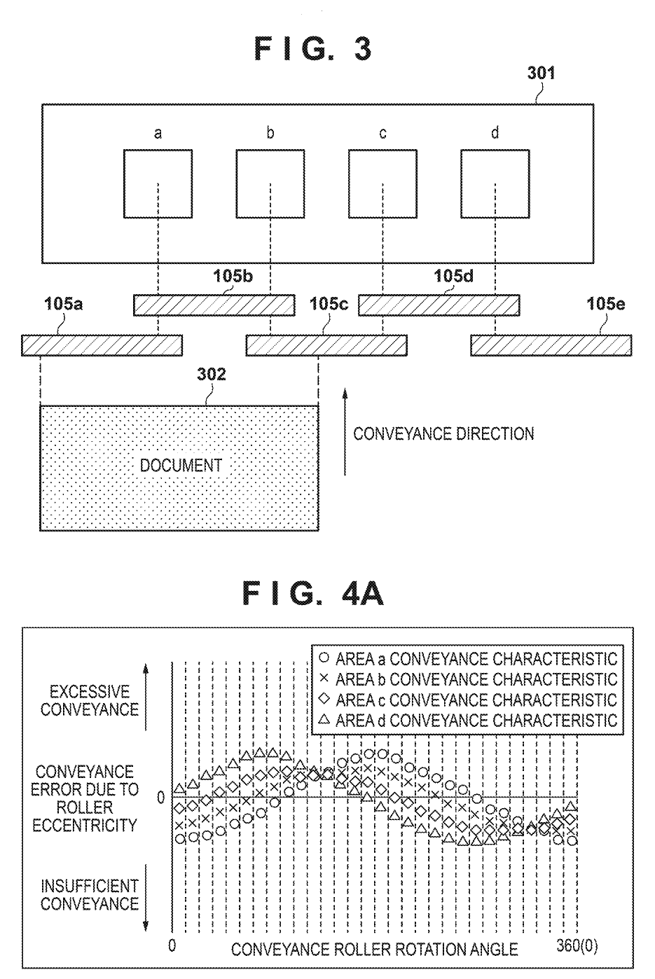

Next, processing at the time of image reading will be described. FIG. 3 shows an eccentricity correction amount calculation chart 301, a read document 302, and image sensor units 105ato 105eused for acquisition of eccentricity information of the conveyance rollers 103, 104 in the multifunction peripheral 100 (image reading apparatus). The eccentricity correction amount calculation chart 301 is read when acquiring eccentricity information in area a to area d, which are overlapping portions (areas where parts overlap each other) of each image sensor. A reason for acquiring eccentricity information in the overlapping portions of the image sensors is that displacement during image correction due to eccentricity becomes pronounced in joint portions of read images.

Eccentricity information is acquired as data for one rotation based on the HP sensor 111. Eccentricity can be measured by expansion and contraction of an image when the upstream conveyance roller 103 is rotated by a rotation angle θ and the image is read based on pulses of the encoder sensor 109. If an image read by conveying a certain rotation angle θ has expanded with respect to a reference image, it indicates that conveyance is small within rotation angle θ, and if it has contracted, it indicates that conveyance is large within rotation angle θ.

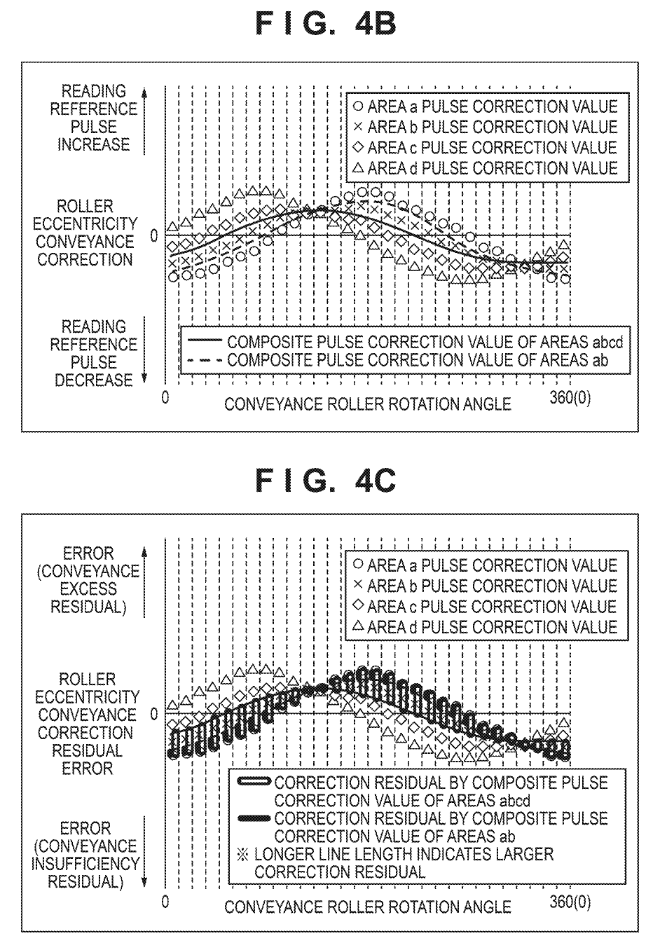

FIGS. 4A-4C are views showing a conveyance state of a document due to eccentricity of a conveyance roller. FIG. 4A is a graph in which expansion/contraction states of images in each of area a to area d (see FIG. 3) of every constant width in the main scanning direction (x direction: a direction orthogonal to or intersecting the document conveyance direction) are plotted based on images acquired for each angle θ. Since the conveyance rollers 103, 104 have a configuration in which rubber rollers are discretely arranged on a metal shaft as described above, it is shown that the phase of eccentricity differs for each area in the main scanning direction according to the eccentricity state of each rubber roller.

When trying to reduce influence due to eccentricity at the time of reading an image, correction is possible by changing reading timing according to an actual conveyance amount including an eccentricity component at the time of document reading. For example, in a rotation angle area of excessive conveyance, reading counts are increased relative to a pulse count of the encoder sensor 109 that generates pulses at constant intervals, and in an area of insufficient conveyance, reading counts are decreased relative to the pulse count of the encoder sensor 109, whereby reading resolution on a paper surface can be made constant.

FIG. 4B is a view showing correction information for the conveyance roller having eccentricity shown in FIG. 4A. In FIG. 4B, a solid line is a graph of parameters showing a case where correction is performed in consideration of changes in conveyance amounts of four areas of area a to area d, and a broken line is a graph of correction parameters showing a case where correction is performed limited to changes in conveyance amounts of two areas of a and b. Correction is performed by increasing/decreasing a reading timing signal for each rotation angle of the upstream conveyance roller 103. That is, if correction information is on a side where reading reference pulses are increased from 0, pulses between reading timings are increased at that rotation angle. Also, if it is on a side where reading reference pulses are decreased, pulses between reading timings are decreased at that rotation angle. In this way, by changing reading timing during conveyance of a document, an image can be formed while making a conveyance distance between reading timings on the paper surface constant regardless of the phase angle of the roller.

However, since the correction value is of one type regardless of the area, in a case where the phase of eccentricity of the conveyance roller differs for each area in the main scanning direction (area a to area d) as shown in FIG. 4A, it is necessary to average corrections for each area. In a case where one type of correction value is applied by averaging corrections, a correction residual may remain in each area.

FIG. 4C is a view showing a correction residual of area a in a case where a correction value is created by changing (selecting) an applied area among area a to area d. A correction residual shown by an open oblong circle is a residual occurring in area a when correction is performed using a correction value created by taking into account all areas from area a to area d. Also, a correction residual shown by a black filled oblong circle is a residual occurring in area a when a correction value is created and correction is performed only in two areas of area a and b. Each length of the oblong circles indicates the magnitude of the correction residual, and since the phases of eccentricity states from area a to d differ, the correction residual becomes larger in a case where a correction value is created in all areas compared to a case where a correction value is created limiting applied areas.

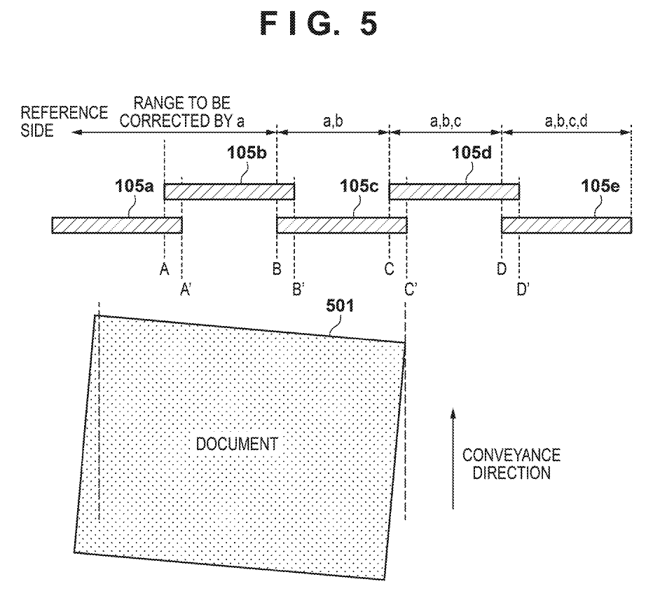

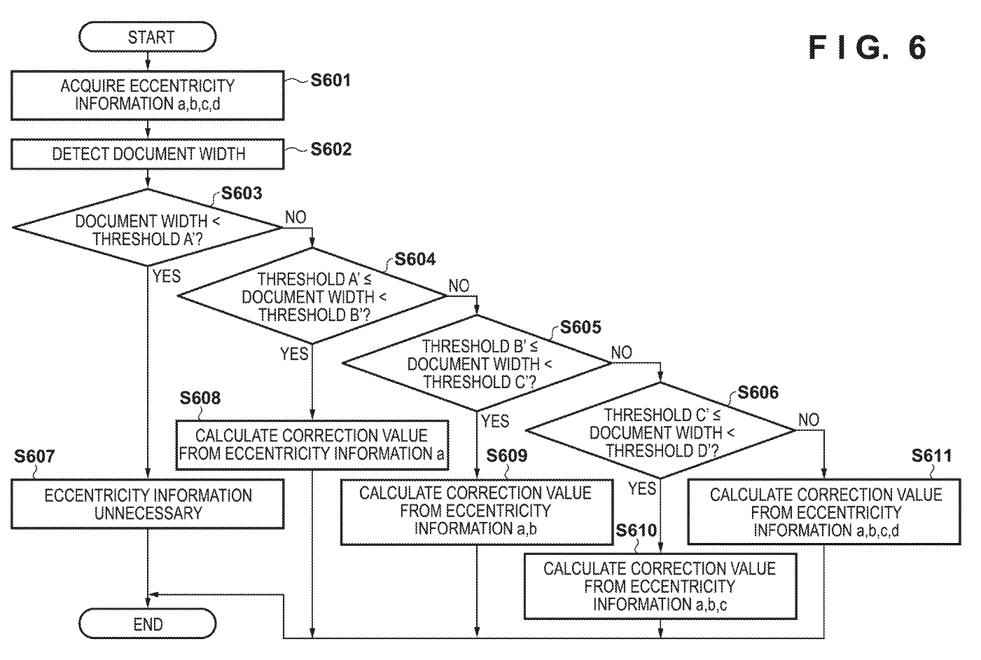

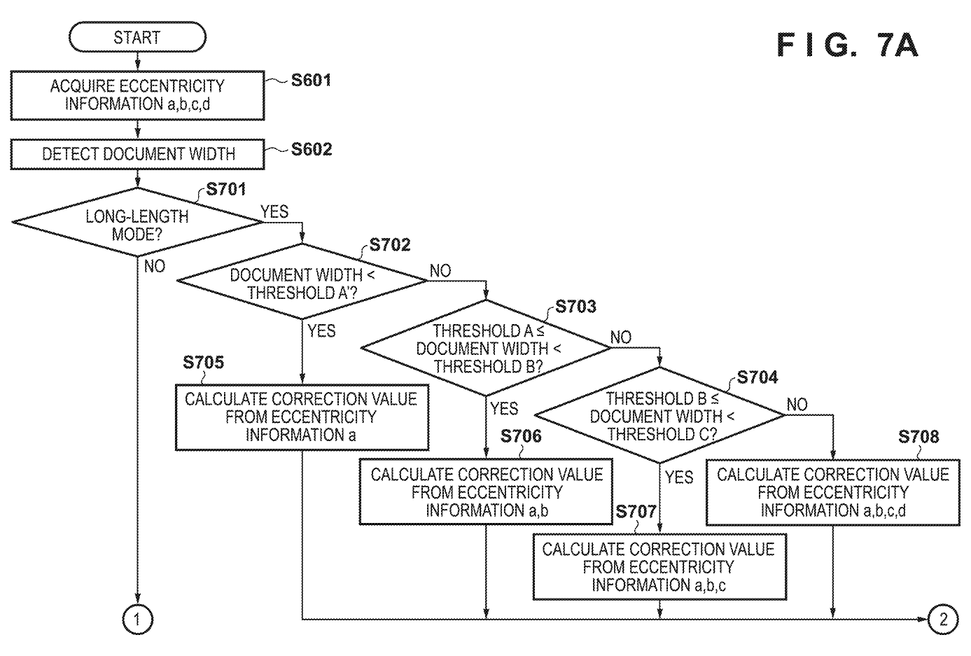

Next, with reference to FIGS. 5 and 6, a method for calculating an optimal correction value according to a read image width in the present embodiment will be described.

FIG. 5 is a view showing a skewed read document 501 and thresholds set for each document width. FIG. 6 is a flowchart showing a calculation operation of a correction value in the present embodiment. The operation of the flowchart of FIG. 6 is realized by the CPU 210 executing a program stored in the memory 210a.

In FIG. 6, in step S601, the CPU 210 acquires eccentricity information in area a to area d of FIG. 3. Eccentricity information is acquired by reading what has been loaded into the DRAM 203 in advance.

In step S602, the CPU 210 detects a document width. Detection of the document width may be achieved by pre-scanning only a document leading edge portion, or a user may set it via a user interface.

In step S603, the CPU 210 compares the document width detected in step S602 with threshold A' among thresholds set for each document width shown in FIG. 5. If the document width is smaller than threshold A', the CPU 210 advances the processing to step S607, and if not, advances the processing to step S604.

In the case of Yes in step S603, the document does not straddle any of area a to area d, and reading is executed only by the image sensor unit 105a. That is, joining of images between image sensors does not occur. Therefore, in step S607, the CPU 210 determines not to perform eccentricity correction.

In step S604, the CPU 210 determines whether the document width detected in step S602 is equal to or greater than threshold A' and less than threshold B'. If the document width is equal to or greater than threshold A' and less than threshold B', the CPU 210 advances the processing to step S608, and if not, advances the processing to step S605.

In the case of Yes in step S604, the document straddles area a, and reading is executed by the image sensor units 105a, 105b. Therefore, in step S608, the CPU 210 calculates a correction value based on eccentricity information regarding area a.

In step S605, the CPU 210 determines whether the document width detected in step S602 is equal to or greater than threshold B' and less than threshold C'. If the document width is equal to or greater than threshold B' and less than threshold C', the CPU 210 advances the processing to step S609, and if not, advances the processing to step S606.

In the case of Yes in step S605, the document straddles areas a, b, and reading is executed by the image sensor units 105a, 105b, 105c. Therefore, in step S609, the CPU 210 calculates a correction value based on eccentricity information regarding areas a, b.

In step S606, the CPU 210 determines whether the document width detected in step S602 is equal to or greater than threshold C' and less than threshold D'. If the document width is equal to or greater than threshold C' and less than threshold D', the CPU 210 advances the processing to step S610, and if not, advances the processing to step S611.

In the case of Yes in step S606, the document straddles areas a, b, c, and reading is executed by the image sensor units 105a, 105b, 105c, 105d. Therefore, in step S610, the CPU 210 calculates a correction value based on eccentricity information regarding areas a, b, c.

In the case of No in step S606, the document straddles all of areas a, b, c, d, and reading is executed by the image sensor units 105a, 105b, 105c, 105d, 105e. Therefore, in step S611, the CPU 210 calculates a correction value based on eccentricity information regarding all areas a, b, c, d.

As described above, in the present embodiment, a correction value is calculated using eccentricity information of an area that a document straddles according to a document width. This makes it possible to generate an appropriate eccentricity correction value using eccentricity information according to a document width. And the CPU 210 performs eccentricity correction processing according to the eccentricity correction value.

### Second Embodiment

In the first embodiment, an appropriate eccentricity correction value is generated according to a document width. On the other hand, even if a document width is known, it is assumed that an area is straddled during reading such as when a read document is skewed or meanders, or when the document width is not constant. In a second embodiment, an example in which an appropriate eccentricity correction value can be calculated even in a case where an area is straddled during reading will be described.

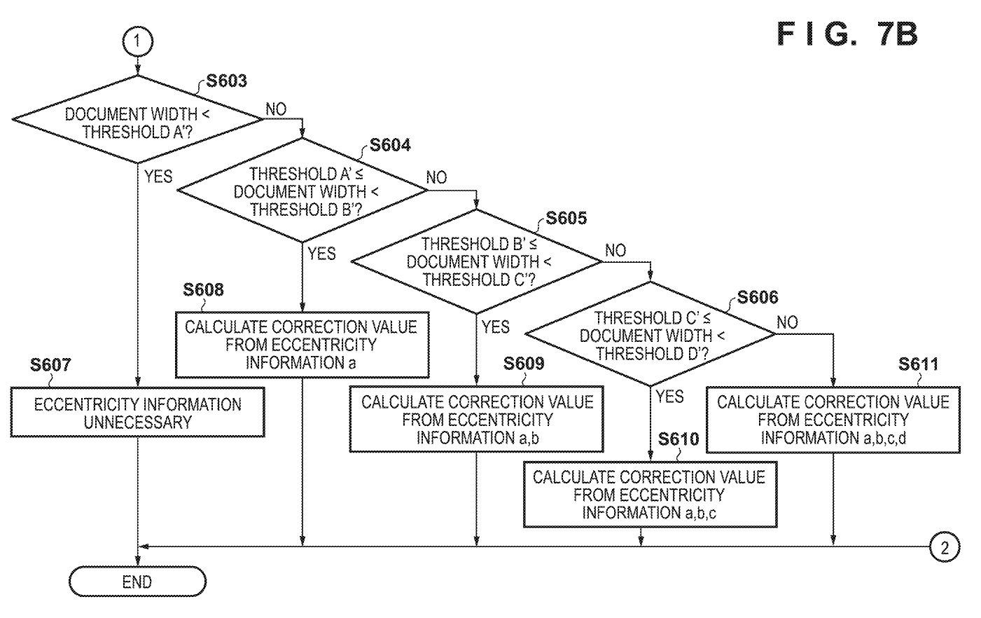

FIGS. 7A and 7B are flowcharts showing a calculation operation of a correction value in the second embodiment. The operation of the flowchart of FIGS. 7A and 7B are realized by the CPU 210 executing a program stored in the memory 210a.

Steps S601 to S611 are similar to the flowchart of FIG. 6 shown in the first embodiment. In FIG. 7A, in step S701, processing for determining a reading mode (operation mode) is added.

In FIG. 7A, in step S701, the CPU 210 performs determination of whether or not a reading mode is a long-length mode. Determination is performed according to, for example, which reading mode is specified by a user via a user interface. If the reading mode is a normal mode, other than the long-length mode, the CPU 210 advances the processing to step S603, and if it is the long-length mode, advances the processing to step S702.

In step S702, the CPU 210 determines whether the document width detected in step S602 is less than threshold A shown in FIG. 5. If the document width is less than threshold A, the CPU 210 advances the processing to step S705, and if not, advances the processing to step S703.

In the case of the long-length mode, it is assumed that displacement of a document in a case of being skewed becomes larger than in a case where the document is short. Therefore, even if the document width is less than threshold A at which reading is possible only by the image sensor unit 105a, it is assumed that the document exceeds threshold A' and reaches the image sensor unit 105b during reading. That is, even if the document width is less than threshold A, there is a possibility of straddling area a, and therefore in step S702, threshold A is used for determination of document width. In the case of Yes in step S702, it is assumed that the document straddles area a and reading is executed by the image sensor units 105a, 105b. Therefore, in step S705, the CPU 210 calculates a correction value based on eccentricity information regarding area a.

In step S703, the CPU 210 determines whether the document width detected in step S602 is equal to or greater than threshold A and less than threshold B shown in FIG. 5. If the document width is equal to or greater than threshold A and less than threshold B, the CPU 210 advances the processing to step S706, and if not, advances the processing to step S704.

In the case of Yes in step S703, it is assumed that the document straddles areas a, b and reading is executed by the image sensor units 105a, 105b, 105c. Therefore, in step S706, the CPU 210 calculates a correction value based on eccentricity information regarding areas a, b.

In step S704, the CPU 210 determines whether the document width detected in step S602 is equal to or greater than threshold B and less than threshold C shown in FIG. 5. If the document width is equal to or greater than threshold B and less than threshold C, the CPU 210 advances the processing to step S707, and if not, advances the processing to step S708.

In the case of Yes in step S704, it is assumed that the document straddles areas a, b, c and reading is executed by the image sensor units 105a, 105b, 105c, 105d. Therefore, in step S707, the CPU 210 calculates a correction value based on eccentricity information regarding areas a, b, c.

In the case of No in step S704, it is assumed that the document straddles all of areas a, b, c, d and reading is executed by the image sensor units 105a, 105b, 105c, 105d, 105e. Therefore, in step S708, the CPU 210 calculates a correction value based on eccentricity information regarding all areas a, b, c, d.

As described above, according to the second embodiment, even if an area is straddled during document conveyance, it becomes possible to apply an appropriate eccentricity correction value to a generated image. The CPU 210 performs eccentricity correction processing according to the eccentricity correction value.

Note that although the long-length mode is used as a determination parameter in step S701, a type of document, a conveyance speed, or the like may be used as the determination parameter.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

What is claimed is:

1. An image reading apparatus comprising:
a conveyance roller that conveys a document;
a plurality of image sensors that read an image of the document conveyed by the conveyance roller;
at least one processor or circuit and a memory storing instructions to cause the at least one processor or circuit to perform operations of the following units:
an acquisition unit that acquires eccentricity information of the conveyance roller for each of a plurality of areas in a direction intersecting a conveyance direction of the document; and
a correction unit that corrects reading timings of the plurality of image sensors based on the eccentricity information,
wherein the correction unit selects eccentricity information to be used for calculation of a correction value from the eccentricity information of the plurality of areas based on a width of the document.

2. The image reading apparatus according to claim 1, wherein the plurality of image sensors are arranged in a direction intersecting the conveyance direction so as to partially overlap each other.

3. The image reading apparatus according to claim 2, wherein the acquisition unit acquires the eccentricity information in areas where the plurality of image sensors overlap each other.

4. The image reading apparatus according to claim 1, wherein the correction unit selects the eccentricity information to be used for calculation of the correction value from the eccentricity information of the plurality of areas by respectively comparing the width of the document with a plurality of thresholds.

5. The image reading apparatus according to claim 4, wherein the thresholds are set based on an operation mode of the image reading apparatus.

6. The image reading apparatus according to claim 5, wherein the operation mode includes a long-length mode in which a long-length document is read.

7. The image reading apparatus according to claim 6, wherein in the long-length mode, each of the plurality of thresholds is set smaller than in a case of an operation mode other than the long-length mode.

8. The image reading apparatus according to claim 1, further comprising a setting unit for a user to set the width of the document.

9. The image reading apparatus according to claim 1, wherein the width of the document is acquired by pre-scanning the document by the image sensors.

10. The image reading apparatus according to claim 1, wherein the correction unit calculates the correction value using the eccentricity information of an area that the width of the document straddles among the plurality of areas.

11. The image reading apparatus according to claim 1, wherein the image sensors are arranged in a direction orthogonal to the conveyance direction.

12. A method for controlling an image reading apparatus comprising a conveyance roller that conveys a document and a plurality of image sensors that read an image of the document conveyed by the conveyance roller, comprising:
acquiring eccentricity information of the conveyance roller for each of a plurality of areas in a direction intersecting a conveyance direction of the document;
correcting reading timings of the plurality of image sensors based on the eccentricity information; and
in the correcting, selecting eccentricity information to be used for calculation of a correction value from the eccentricity information of the plurality of areas based on a width of the document.

13. A non-transitory computer-readable storage medium storing a program for causing a computer to execute each step of a method for controlling an image reading apparatus comprising a conveyance roller that conveys a document and a plurality of image sensors that read an image of the document conveyed by the conveyance roller, the method comprising:
acquiring eccentricity information of the conveyance roller for each of a plurality of areas in a direction intersecting a conveyance direction of the document;
correcting reading timings of the plurality of image sensors based on the eccentricity information;
in the correcting, selecting eccentricity information to be used for calculation of a correction value from the eccentricity information of the plurality of areas based on a width of the document.
